(19) United States
(12) Patent Application Publication
(10) Pub. No.: US 2003/0126554 A1
(43) Pub. Date: Jul. 3, 2003

(54) Document exchange among business-to-business (B2B) partners using meaningful extensible mark-up language (XML)

(76) Inventors: Azad E. Behzadi, Los Angeles, CA (US); John Li, Foothill Ranch, CA (US); Michael Teng, Irvine, CA (US)

Correspondence Address: KENYON & KENYON, One Broadway, New York, NY, 10004, US

(21) Appl. No.: 10/274,090

(22) Filed: Oct. 18, 2002

Related U.S. Application Data
(60) Provisional application No. 60/343,835, filed on Oct. 19, 2001.

(51) Int. Cl. G06F 17/24

(52) U.S. Cl. 715/501.1; 715/542

(57) ABSTRACT

A system and method for checking and validating Extensible Markup Language (XML) data before sending a XML document to a receiving partner. The XML data tags used by Partner A may be incomprehensible to Partner B. A database is used to reformat the XML document based on the compatibility requirements of the receiving party.

### RELATED APPLICATIONS

This application claims the benefit under 35 U.S.C. §119(e) of U.S. provisional application Serial No. 60/343,835, filed Oct. 19, 2001, the contents of which are incorporated herein by reference.

### FIELD OF THE INVENTION

The present invention relates to a system and method for electronic data exchange.

### BACKGROUND INFORMATION

Extensible Markup Language (XML) is a markup language that is similar to Hypertext Markup Language (HTML). XML is specifically configured to describe data and it allows authors of electronic documents to define their own markup tags and document structure. XML is widely used as the standard for business-to-business (B2B) data communication over the Internet. While XML allows for efficient and scalable data communication for businesses, it still requires that business partners structure the XML document for data exchange in a format that is understandable by all the participating business partners.

Current technology does not outline how business partners may exchange XML documents and assure the validity of data in a format that is understood by the receiving partner. As a result, techniques to translate XML structures have emerged to aid business partners in exchanging structured XML documents. XML structure translators function by restructuring XML documents such that data is understandable to all the participating parties. However, XML translators merely validate the syntax and structure of the XML documents. XML translators do not assure the accuracy and validity of the data sent in XML documents and do not assure that the data transmitted in the XML documents is understandable to the partner receiving the XML documents.

### SUMMARY OF THE INVENTION

The system and method according to the present invention check and validate Extensible Markup Language (XML) data before sending a XML document to a receiving partner. A database is used to store all the information required to reformat the XML document based on the needs of the receiving party. The XML document may include text data, audio data, video data or animation data. The data tags of the XML document define the format for the data contained in the XML document. The XML data tags used by Partner A may be incomprehensible to Partner B.

Data tags used by Partner A in the XML document are evaluated to see if the data tags in the XML document are understandable to Partner B. If the data tags used by Partner A are understandable to Partner B, the XML document is transmitted to Partner B. If the data tags used by Partner A are not understandable by Partner B, a determination is made as to which data tags are understandable to Partner B. The database is referenced in order to match Partner A's data tags with other data tags that are understandable to Partner B. The data tags used by Partner A in the XML document are replaced by the other data tags that are understandable to Partner B. This results in a XML document that is understandable to Partner B.

Exemplary embodiments of the present invention are shown in the drawings and explained in the description which follows.

### BRIEF DESCRIPTION OF THE DRAWINGS

FIG. 1 shows an exemplary method according to the present invention.

FIG. 2 shows an exemplary system according to the present invention.

FIG. 3 shows a XML document as it is formatted by a sender and the reformatted XML document as it received by the recipient.

### DETAILED DESCRIPTION

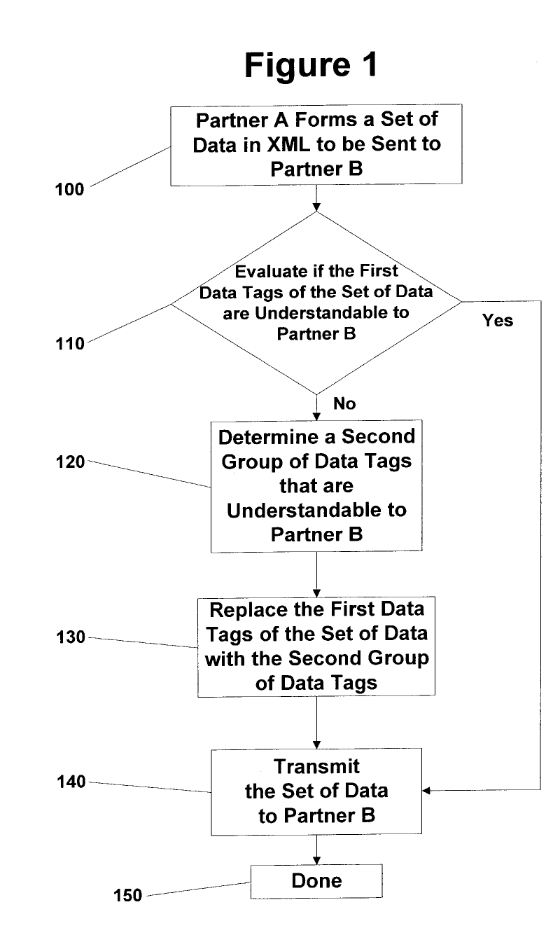

FIG. 1 shows an exemplary method according to the present invention. The method involves performing an Extensible Markup Language (XML) data exchange between two business partners and validating the XML data before transmission. The XML document includes a set of data that may be text data, audio data, video data or animation data. For example, the XML document sent by partner A may refer to a product such as an “automobile”, but Partner B is only able to understand the same product as a “car”. In XML, Partner A's XML data tag for “automobile” may be “<product=automobile/>” and Partner B's XML data tag for “car” may be “<product=car/>”. The XML data tags define the format for the data contained in the XML document. In step 100, Partner A forms a XML document with a set of data that is to be sent to Partner B. The XML data tags used by Partner A may be incomprehensible to Partner B, as seen by the “automobile” and “car” example above. In step 110, the data tags used by Partner A in the XML document are evaluated to determine if the data tags in the XML document are understandable to Partner B. The evaluation of the data tags is performed by referencing a database that stores the data tags used by Partner A and the data tags that are understandable to Partner B. The database stores a record for each data tag that Partner A uses. For example, the database includes a record for Partner A's XML data tag for automobile (<product=automobile/>) and this record also includes a corresponding data tag that is understandable to Partner B (<product=car/>). During the evaluation, the database record of the XML data tag used by Partner A is referenced and the XML data tag is checked to see if it matches the corresponding XML data tag understandable to Partner B. In some cases the XML document is already understandable to Partner B, i.e., a XML data tag used by Partner A (<symbol=letter/>) is the same as the XML data tag that is understandable to Partner B (<symbol=letter/>), and step 140 occurs in order to transmit the XML document to Partner B. If the XML data tags used by Partner A are not understandable by Partner B, i.e. Partner A's XML data tag is “<product=automobile/>” and the XML data tag that is understandable to Partner B is “<product=car/>”, step 120 occurs and a determination is made as to which XML data tag is understandable to Partner B. In step 120, the database is referenced in order to match Partner A's XML data tags with other XML data tags that are understandable to Partner B. For example, the database includes a record for Partner A's XML data tag for automobile (<product=automobile/>). This record also includes a corresponding data tag that is understandable to Partner B (<product=car/>). When the XML data tags of Partner A are evaluated, the proper record of the database is referenced in order to retrieve the data tag that is understandable to Partner B. Then in step 130, the data tags used by Partner A in the XML document are replaced by the other data tags that are understandable to Partner B. For example, Partner A's XML data tag for automobile “<product=automobile/>” is replaced with “<product=car/>”, which is understandable to Partner B. This results in a XML document that is understandable to Partner B. In step 140, the XML document is transmitted to Partner B. In step 150, the method is completed.

An exemplary embodiment of the database and its tables is as follows:

global_structure_identifier table:

| id | name | category |
|---|---|---|
| 1 | unique_product_identifier | product |

global_value table:

| id | global_structure_id | name | category |
|---|---|---|---|
| 1 | 1 | SKU | product |
| 2 | 1 | manufacturer | product |
| 3 | 1 | UPC | product |

SKU stands for Stock Keeping Unit.
UPC stands for Universal Product Code.

partner_specific_value table:

| id | global_value_id | partner | value |
|---|---|---|---|
| 1 | 1 | A | 123 |
| 2 | 2 | A | ABC |
| 3 | 1 | A | 123 |
| 4 | 2 | A | BCE |
| 5 | 3 | B | ABC_123_001 |
| 6 | 3 | B | BCE_121_M1 |

partner_specific_xml_path table:

| id | partner | gl_str_id | xpath_id | composite_flag | parent_id | xml_type |
|---|---|---|---|---|---|---|
| 1 | A | 1 | /doc/product | Y | | element |
| 2 | A | 1 | @ SKU | Y | 1 | attribute |
| 3 | A | 1 | @ manufacturer | Y | 1 | attribute |
| 4 | B | 1 | doc/product | Y | | element |
| 5 | B | 1 | UPC | Y | 4 | element |

partner_data_translation table:

| group_id | partner_specific_xml_path_id | partner_specific_value |
|---|---|---|
| 1 | 1 | |
| 1 | 2 | 1 |
| 1 | 3 | 2 |
| 1 | 4 | |
| 1 | 5 | 5 |
| 2 | 1 | |
| 2 | 2 | 3 |
| 2 | 3 | 4 |
| 2 | 4 | |
| 2 | 5 | 6 |

In this data implementation, Partner A forms a XML document where a product is identified by its SKU number and the name of its manufacturer.

Partner A's XML document:

<doc>
<product SKU = “123” manufacturer = “ABC”/>
</doc>

Partner B identifies the product by its UPC number and is unable to understand the SKU number and the manufacturer name.

Partner A's XML document is converted to a XML document that is understandable to Partner B based on the product tag. First, the global_structure_identifer table is search in order to find the id number that corresponds to the product tag. In this case, the product's id is 1 and the global_structure id is 1. This id is searched for in the partner_specific_xml_path table. Id 1 is found in the partner_specific_xml_path table at rows with ids 1, 2, and 3. The value context of these rows are extracted by referencing the xpath_id column of the partner_specific_xml_path table. The xpath_id column provides the storage location of the data in the XML document. Next, a joint search is executed against the global_value table, the partner_specific_value table and the partner_data_translation table based on values supplied by Partner A. The joint search provides return values for Partner B that correspond to values of Partner A that have the same group_id as values understandable to Partner B as stored in the partner_data_translation table. In this case, the return value is group_id=1 for both the first set of XML data tags of Partner A and for corresponding Partner B values that allow constructing the data tags for the XML document that is understandable to Partner B.

After referencing the database as described above, the XML document that is transmitted to and is understandable to Partner B is as follows:

```
<doc>
  <product>
  <UPC>ABC_123_001</UPC>
  </product>
</doc>
```

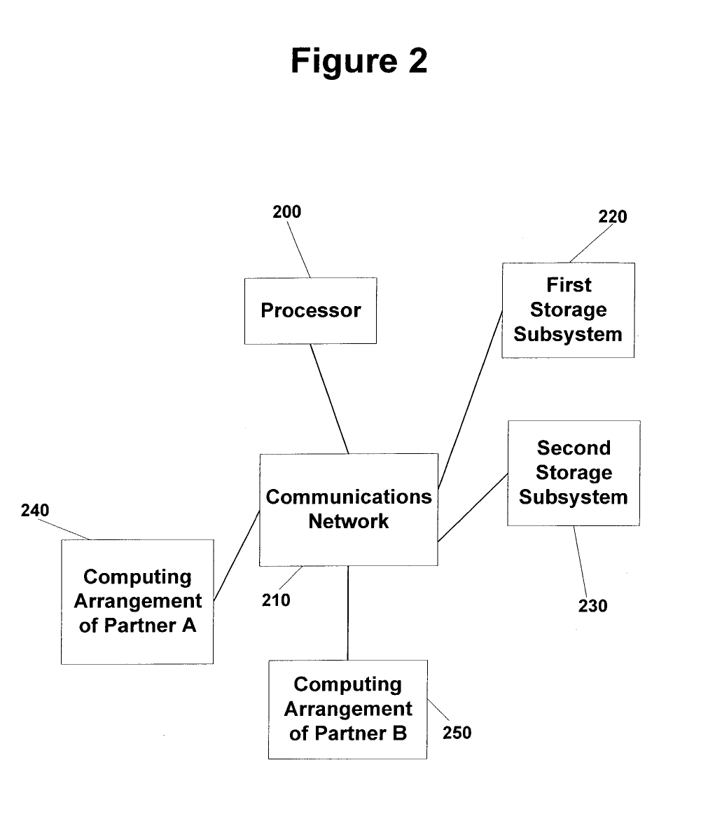

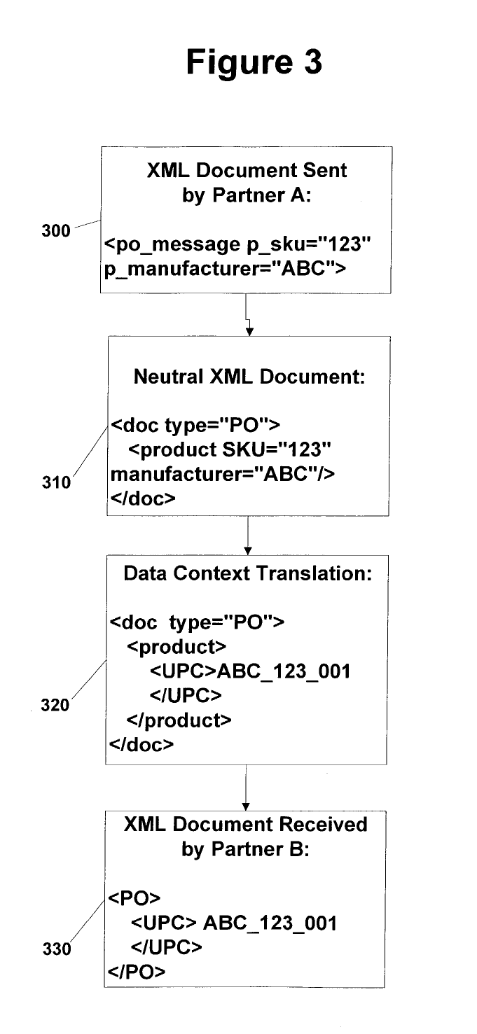

FIG. 2 shows an exemplary system according to the present invention. The system is configured to execute the method described above in reference to FIG. 1. A processor 200 executes the method according to the present invention. The processor 200 may include a computer server arrangement. The method according to the present invention is stored as a set of instructions that is accessible and executable by the processor 200. This set of instructions is stored in a first storage subsystem 220 that may be a compact disk, hard drive, DVD-ROM, CD-ROM or any type of computer-readable storing medium. The first storage subsystem 220 may be included within a computing arrangement 240 of Partner A. Within the system, Partner A uses the computing arrangement 240 to create a XML document. The computing arrangement 240 of Partner A may be a personal computer, a computer network, a wireless computing device or a wireless computing network. The computing arrangement 240 of Partner A communicates with the processor 200 via a communications network 210. Partner A uses the computing arrangement 240 to send the XML document to Partner B. Before the XML document is sent to Partner B, the XML document is transferred to the processor 200 via the communications network 210. The processor 200 uses the set of instructions stored on the first storage subsystem 220 to validate the XML document by manner of the exemplary method according to the present invention. A second storage subsystem 230 includes a database that stores various XML data tags used by Partner A, the sender of the XML document, and information regarding compatibility with XML data tags used by Partner B, the recipient of the XML document. An exemplary embodiment of the database is described above. The second storage subsystem 220 may be included within the computing arrangement 240 of Partner A. The processor 200 communicates with the database stored on the second storage subsystem 230 and the first storage subsystem 220 via the communications network 210. The processor 200 validates whether the XML document is understandable to Partner B on the basis of the set of instructions and the information stored in the database. If necessary the processor 200 replaces the data tags of the XML document in order to reformat the XML document in a manner that is understandable to Partner B. After the XML document has been validated and reformatted to be understandable to Partner B (as described in reference to FIG. 1, the exemplary embodiment of the database and FIG. 3), the processor 200 uses the communications network 210 to transmit the XML document to the computing arrangement 250 of Partner B.

FIG. 3 shows a XML document as it is formatted by a sender and the reformatted XML document as it received by the recipient. The XML document 300 is a format that Partner A understands. The XML document 300 includes a first plurality of data tags that conform to the XML standard. The XML document 300 is reformatted as a neutral XML document 310. The neutral XML document is reformatted into a data context translation document 320. The plurality of data tags are replaced, by manner of the method described above in reference to FIG. 1 and the exemplary embodiment of the database, with a second plurality of data tags that are understandable to Partner B. This results in a XML document 330 that is understandable to Partner B and this is the XML document 330 received by Partner B.

What is claimed is:

1. A method for data transfer, comprising:
(a) forming a set of data that includes a first plurality of data tags, the first plurality of data tags configuring a content of the set of data by defining a first format for the content;
(b) evaluating the first plurality of data tags to determine whether the first plurality of data tags are understandable to a recipient of the set of data;
(c) determining a second format for the content that is understandable to the recipient of the set of data;
(d) replacing the first plurality of data tags with a second plurality of data tags that corresponds to the second format; and
(e) transmitting the set of data to the recipient;
wherein the first plurality of data tags, the first format, the second plurality of data tags and the second format conform to the Extensible Markup Language (XML) standard.

2. The method of claim 1, wherein the evaluation step (b) involves referencing a database to determine the second format by matching the first format with the second format that is identified in the database as understandable to the recipient.

3. The method of claim 1, wherein the transmission step (e) is performed using a computing arrangement in communication with a processor via a communications network.

4. The method of claim 3, wherein the processor includes a computer server arrangement.

5. The method of claim 1, wherein the set of data includes at least one of: text data, audio data, video data, and animation data.

6. A computer-readable storing medium storing a set of instructions, the set of instructions capable of being executed by a processor to implement a method for data transfer, the set of instructions performing the steps of:
(a) forming a set of data that includes a first plurality of data tags, the first plurality of data tags configuring a content of the set of data by defining a first format for the content;
(b) evaluating the first plurality of data tags to determine whether the first plurality of data tags are understandable to a recipient of the set of data;
(c) determining a second format for the content that is understandable to the recipient of the set of data;
(d) replacing the first plurality of data tags with a second plurality of data tags that corresponds to the second format; and
(e) transmitting the set of data to the recipient;
wherein the first plurality of data tags, the first format, the second plurality of data tags and the second format conform to the Extensible Markup Language (XML) standard.

7. The computer-readable storing medium of claim 6, wherein the evaluation step (b) involves referencing a database to determine the second format by matching the first format with the second format that is identified in the database as understandable to the recipient.

8. The computer-readable storing medium of claim 6, wherein the transmission step (e) is performed using a computing arrangement in communication with the processor via a communications network.

9. The computer-readable storing medium of claim 8, wherein the processor includes a computer server arrangement.

10. The computer-readable storing medium of claim 6, wherein the set of data includes at least one of: text data, audio data, video data, and animation data.

11. A system comprising:
a processor;
at least one computing arrangement configured to communicate with the processor via a communications network; and
a computer-readable storing medium storing a set of instructions, the set of instructions capable of being executed by the processor to implement a method for data transfer, the set of instructions performing the steps of:
(a) forming a set of data that includes a first plurality of data tags, the first plurality of data tags configuring a content of the set of data by defining a first format for the content;
(b) evaluating the first plurality of data tags to determine whether the first plurality of data tags are understandable to a recipient of the set of data;
(c) determining a second format for the content that is understandable to the recipient of the set of data;
(d) replacing the first plurality of data tags with a second plurality of data tags that corresponds to the second format; and
(e) transmitting the set of data to the recipient;
wherein the first plurality of data tags, the first format, the second plurality of data tags and the second format conform to the Extensible Markup Language (XML) standard.

12. The system of claim 11, wherein the evaluation step (b) involves referencing a database to determine the second format by matching the first format with the second format that is identified in the database as understandable to the recipient.

13. The system of claim 11, wherein the transmission step (e) is performed using the at least one computing arrangement in communication with the processor via the communications network.

14. The system of claim 11, wherein the processor includes a computer server arrangement.

15. The system of claim 11, wherein the set of data includes at least one of: text data, audio data, video data, and animation data.
